(19) United States
(12) Patent Application Publication
(10) Pub. No.: US 2025/0379369 A1
(43) Pub. Date: Dec. 11, 2025

(54) Mmid Localization And Orientation Sensing Via Frequency-Divided Beam Multiplexing

(71) Applicant: The Regents of The University of Michigan, Ann Arbor, MI (US)

(72) Inventors: Jimmy HESTER, Ann Arbor, MI (US); Skanda HARISHA, Ann Arbor, MI (US); Aline EID, Ann Arbor, MI (US)

(73) Assignee: The Regents of The University of Michigan, Ann Arbor, MI (US)

(21) Appl. No.: 19/227,752

(22) Filed: Jun. 4, 2025

Related U.S. Application Data
(60) Provisional application No. 63/656,220, filed on Jun. 5, 2024.

(51) Int. Cl. H01Q 21/06; G01S 7/41; H01Q 9/04; H01Q 15/02; H01Q 21/29

(52) U.S. Cl. CPC H01Q 21/065; G01S 7/411; H01Q 9/0407; H01Q 15/02; H01Q 21/29

(57) ABSTRACT

Localizing objects and determining their accurate position and orientation at considerable distances within densely cluttered environments poses a formidable challenge. This disclosure introduces a new approach utilizing ultralow-power frequency-divided backscatter beams on a single tag to enable azimuth estimation. The mm-wave system leverages a cross-polarizing Rotman lens and radar system for its implementation. Testing results for the system underscore the tag's ability to achieve precise localization over more than 10 m of range with a median error of 6.4 cm, while also accurately determining orientation with a mean absolute error of 3.6°. This disclosure not only addresses the pressing challenge of object localization and orientation detection but also lays a foundation for future advancements in extended-range sensing technology.

### CROSS-REFERENCE TO RELATED APPLICATIONS

This application claims the benefit of U.S. Provisional Application No. 63/656,220, filed on Jun. 5, 2024. The entire disclosure of the above application is incorporated herein by reference.

### FIELD

The present disclosure relates to millimeter wave tags for localization and orientation sensing.

### BACKGROUND

Whether we're deploying autonomous vehicles, using mixed reality headsets, or tracking inventory in a warehouse, accurate localization and orientation detection are indispensable. These technologies enable us to pinpoint the exact position of the object of interest in a physical space and determine its orientation relative to the surroundings, forming the foundation for a myriad of applications that enhance our daily experiences. Augmented reality, for instance, cannot operate without accurate location and orientation information that is required at each instance to support the highly demanding dynamic applications.

The use of RFID's for localization and orientation detection has gained popularity as RFID's are cheap, they don't need an optical line of sight and can operate passively or by consuming negligible amount of power. Some researchers employed polarization and RSSI parameters for orientation determination, while other researchers pursued a phase-based approach. However, these RFID systems are limited to very short ranges and suffer from a high latency, parameters that cannot be ignored in today's highly dynamic environments. So how does one retain some of the good traits of RFID while also overcoming its limitations?

Recently there has been a surge in the use of millimeter wave tags (a.k.a. mmIDs) for localization and orientation sensing. This is due to the fact that these frequencies offer higher bandwidth—therefore, increased range resolutions—and enhanced ranges due to more directive beams. However, these systems inherently exhibit very short ranges.

A significant number of recent efforts have also demonstrated the benefits of using opposite polarization transmission (TX) and receiving (RX) channels in mmID reader systems to reduce self-interference and, consequently, lower the noise floor and extend the reading range of such hardware.

### SUMMARY

This section provides a general summary of the disclosure, and is not a comprehensive disclosure of its full scope or all of its features.

A localization and orientation sensing tag is presented. The tag is comprised of: a Rotman lens having a plurality of array ports and a plurality of beam ports; a set of receiving antennas; a set of transmitting antennas; a set of switches; and a baseband circuit interfaced with each switch in the set of switches. Each antenna in the set of receiving antennas is electrically coupled to a different port in the array of ports of the Rotman lens; and each antenna in the set of transmitting antennas is electrically coupled to a different port in the plurality of beam ports of the Rotman lens. A switch from the set of switches is disposed in each path electrically coupling a port in the plurality of beam ports to an antenna in the set of transmitting antennas.

In one embodiment, the receiving antennas are further defined as patch antennas. The antennas in the set of receiving antennas are vertically polarized; whereas, the antennas in the set of transmitting antennas are horizontally polarized.

In operation, the baseband circuit operates to modulate signals at different frequencies prior to the signals reaching an antenna in the set of transmitting antennas. The baseband circuit modulates signals by turning on and off switches in the set of switches.

In some embodiments, the sensing tag is integrated into a vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram depicting a vehicle equipped with an improved sensing tag according to this disclosure.

FIG. 2 is a diagram further depicting an example embodiment of a localization and orientation sensing tag.

FIG. 3 is a graph showing the simulated gain of the Rotman lens structure at different angles. The ports responsible for the beams are sequential from beam Port 1 to Port 6.

FIG. 4 is a schematic of an example implementation for the baseband circuit.

FIG. 5 is a graph showing the measured power consumption of the switch with respect to frequency.

FIG. 6 is an illustration of a fabricated cross-polarized sensing tag.

FIG. 7A is a graph showing the measured power spectrum for the sensing tag.

FIG. 7B is a graph showing frequency versus angle of arrival response of the sensing tag placed at 38 degrees from the normal plane of the radar.

FIG. 8 shows how the unwanted frequencies, clutter and harmonics are removed from a sensing signal.

FIG. 9 is a graph showing the measured radar cross-section of the sensing tag.

FIG. 10A is a graph showing the signal-to-noise ratio of the sensing tag in relation to range.

FIG. 10B is a graph showing the measured error in orientations.

Corresponding reference numerals indicate corresponding parts throughout the several views of the drawings.

### DETAILED DESCRIPTION

Example embodiments will now be described more fully with reference to the accompanying drawings.

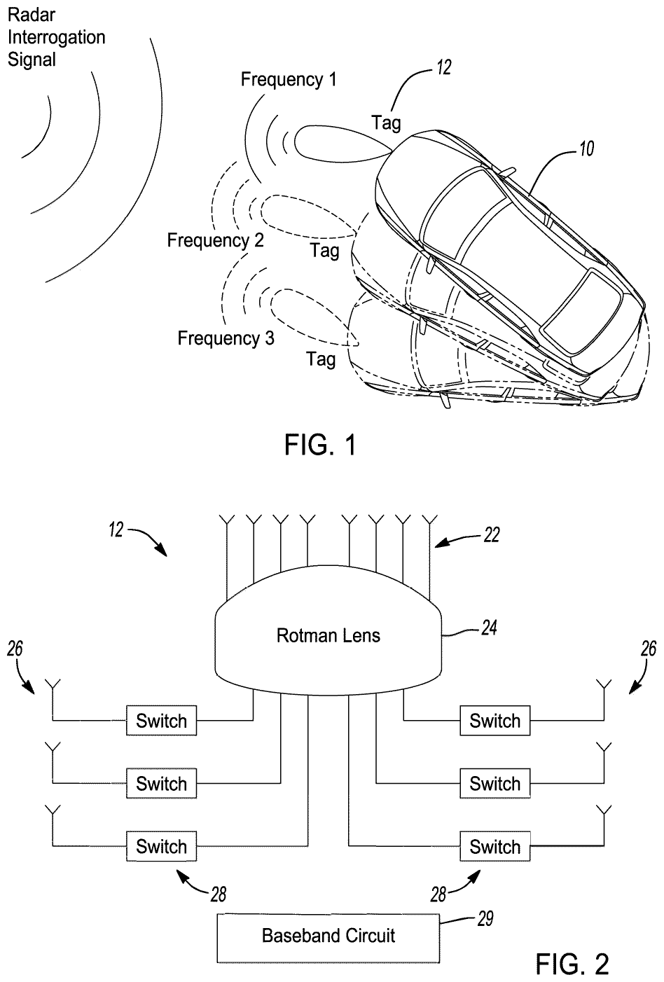

FIG. 1 depicts a vehicle 10 equipped with an improved sensing tag 12 that utilizes frequency-divided beam multiplexing to communicate orientation. Radars are able to accurately and quickly estimate the location and orientation of the vehicle 10 using the improved sensing tag 12.

FIG. 2 further depicts an example embodiment of a localization and orientation sensing tag 12 in accordance with this disclosure. The sensing tag is comprised of a set of receiving antennas 22, a Rotman lens 24, a set of transmitting antennas 26, a set of switches 28 and a baseband circuit 29. Each of these components is further described below.

In the example embodiment, each of the receiving antennas 22 is further defined as a patch antenna. Likewise, each of the transmitting antennas 26 is further defined as a patch antenna. The antenna type may be selected based on the application. Other types of antennas are contemplated by this disclosure including but not limited to Yagi antennas, horn antennas and dipole antennas.

Additionally, the receiving antennas 22 preferably employ different polarization from the transmitting antennas 26. In the example embodiment, the receiving antennas 22 are vertically polarized while the transmitting antennas 26 are horizontally polarized. The opposite arrangement for polarizing the antennas is also suitable.

A Rotman lens 24 includes a plurality of array ports and a plurality of beam ports. Each antenna in the set of receiving antennas 22 is electrically coupled to a different port in the array of ports of the Rotman lens 24; whereas, each antenna in the set of transmitting antennas 26 is electrically coupled to a different port in the plurality of beam ports of the Rotman lens 24. During operation, beams incident on the set of receiving antennas may arrive from different directions and the Rotman lens directs the beams to different beam ports depending on the angle of incidence. While reference is made throughout this disclosure to a Rotman lens, other types of beam forming networks also fall within the scope of this disclosure, including planar implementations, such as a Butler matrix, a Blass matrix, or a Nolen matrix, as well as three-dimensional implementations, such as a dielectric lens, a Frensel lens or a Luneburg lens.

Prior to the received signals reaching an antenna in the set of transmitting antennas, the baseband circuit 29 operates to modulate the signals at different frequencies. In the example embodiment, switches from the set of switches 28 are disposed in each path electrically coupling a port in the plurality of beam ports to an antenna in the set of transmitting antennas 26. The baseband circuit 29 is interfaced with each switch in the set of switches 28 and modulates signals by turning on and off switches in the set of switches 28. The example embodiment for the sensing tag 12 is further described below.

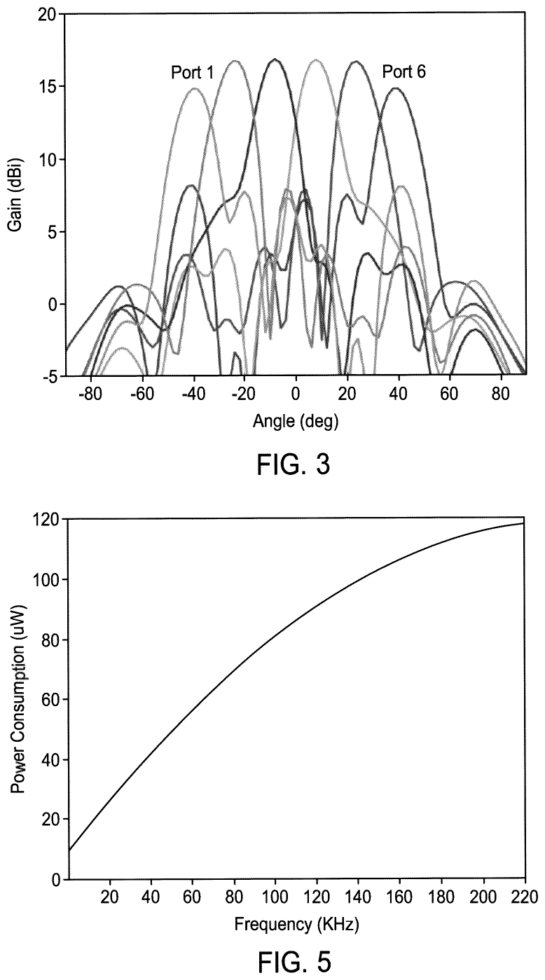

As proof of concept, the Rotman lens 24 was simulated using CST Microwave Studio. In the example implementation, a substrate of 20 mil Rogers 4350B (ϵᵣ=3.48) was utilized. Six beam ports and eight antenna ports were employed to achieve a balance between gain and angular coverage although more or less ports may be implemented. Each antenna port is connected to a vertically polarized serial patch antenna array with a gain of 12 dBi. Then, the lens—along with the series-fed patch antennas—was simulated using Ansys HFSS. The simulated gain obtained via the excitation of each individual beam port is shown in FIG. 3. It can be seen that the structure has a good gain of nearly more than 15 dBi from −40° to 40°. Finally, each beam port is routed via a switch to a horizontally polarized transmitting antenna array with a gain of 10 dBi.

For the RF switches, an ultra-low power switch was designed using high-frequency low noise CEL CE3520K3 transistors. Its source terminals are linked to quarter-wave radial stubs, responsible for creating a virtual ground, while its drain is loading a quarter-wave stub stemming from the switch's associated beam port. Consequently, when a square wave is applied to the switch's drain, the input impedance of the stub cyclically alternates between open and short circuit states. This change in impedance modulates the interrogating signal. Other types of switches also fall within the scope of this disclosure.

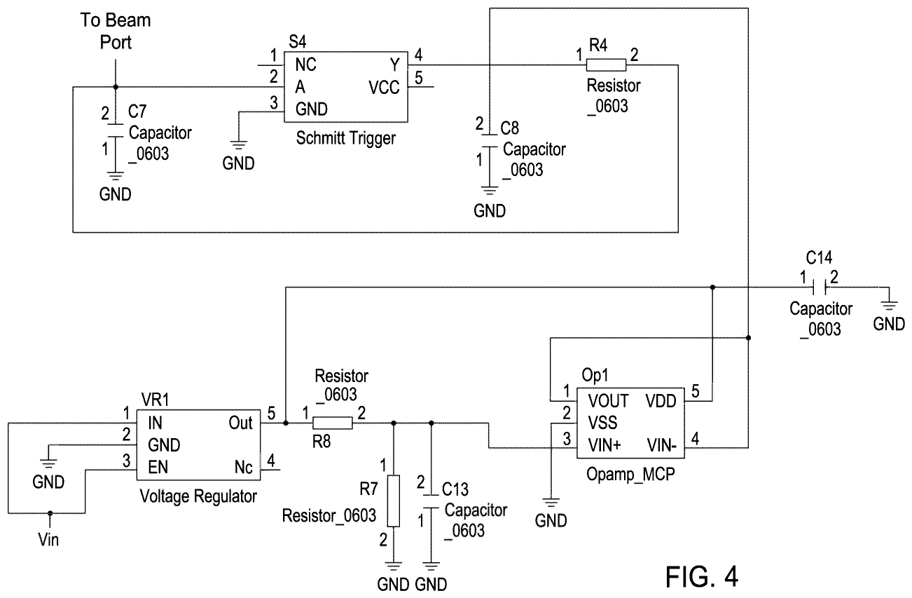

FIG. 4 is a schematic for an example implementation for the baseband circuit 29. The baseband circuit 29 is comprised of two primary components: the power supply unit and the oscillators. An ultra-low-power voltage regulator is employed to stabilize the voltage of the primary power source and guarantee the stable operation of the oscillators. This is followed by a voltage follower circuit, designed to trim the regulated voltage down to a level of about 1V, necessary for the low-power operation of the following oscillators. It is then directed to various Schmitt trigger-based relaxation oscillators connected in parallel. Each oscillator is set to a different frequency by tuning the RC time constant of its feedback connection before its output is directed towards one of the beam ports of a Rotman lens. In FIG. 5 depicts the variation of the power consumption of a single oscillator as a function of its frequency. It shows an almost linear increase in the power consumption due to its dominant dynamic component generated by the periodic charging and discharging of the capacitors of the relaxation oscillator.

The tag is designed to be cross polarized due to the aforementioned advantages. That is, the tag can receive signals in horizontal polarization and backscatter them in vertical polarization, and vice versa. To interrogate this system, an off-the-shelf cross-polarized Frequency Modulated Continous Wave (FMCW) GreatEye radar from Atheraxon Inc was utilized. This radar chirps from 24 GHz to 24.25 GHZ over the course of 3.4 ms and boasts 8 receive (placed λ/2 apart) and 2 transmit channels, providing excellent angular coverage and resolution. It has an EIRP of 25 dBm. Operating with a transmission of horizontal polarization and reception of vertical polarization, the radar facilitates a comprehensive exploration of the system.

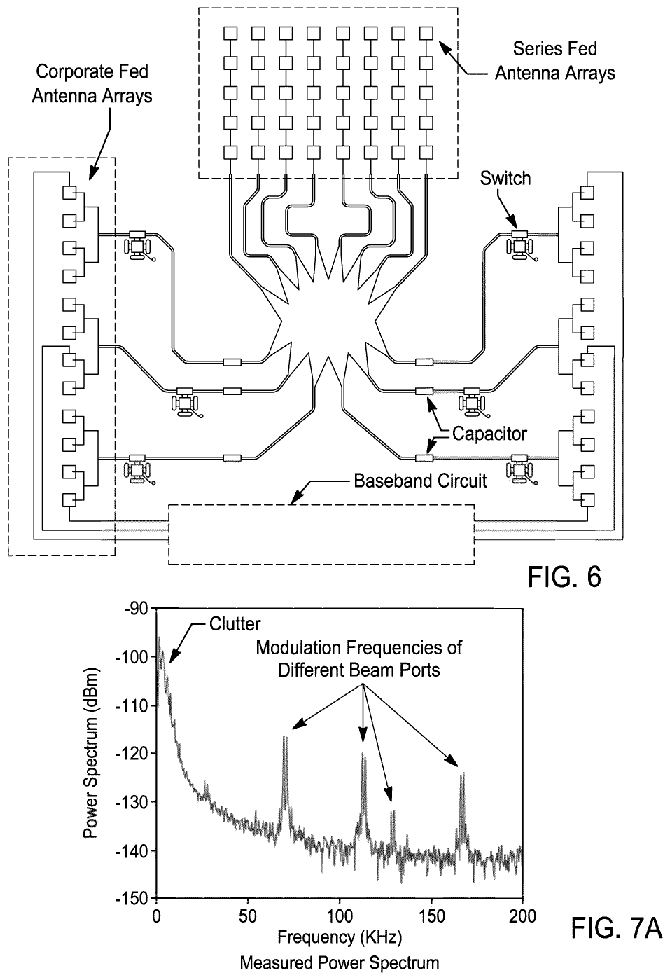

FIG. 6 depicts the fabricated tag structure. Regarding its functionality, it is first essential to note the tag's complete reciprocity, enabling operation in both horizontal receive and vertical transmit, as well as vertical receive and horizontal transmit configurations. The system currently employed uses the former configuration, i.e. all corporate-fed horizontal polarization antennas attached to the beam ports of the lens can receive signals, forward it to the array ports and generate six different beams simultaneously, each directed towards different directions in azimuth. Depending on the orientation of the tag relative to the radar, the beam corresponding to a particular beam port will exhibit the highest signal strength. As the orientation of the tag changes, the signal from other beam ports becomes dominant. This concept forms the core of the tag's functionality.

Each beam port was configured to be modulated at different frequencies ranging from 30 kHz to 170 kHz. Considering that the baseband modulation signal is approximately a square wave, comprising mostly odd integer harmonics, the frequencies were carefully spaced in the frequency domain to minimize interference. All the selected frequencies were relatively high in order to allow them to be distinguished from the clutter captured by the reader, created by passive targets in the FMCW process.

Another aspect of the tag design involves feeding different modulation frequencies to various beam ports. In this setup, the modulation signals are fed at the midpoint of the antennas, leveraging a null in the voltage at that location to reduce any mismatch. Additionally, it's imperative for each beam port to be electrically isolated from one another to prevent interference between modulation frequencies. To achieve this, a capacitor is disposed in each path electrically coupling a port in the plurality of beam ports to an antenna in the set of transmitting antennas. For example, one can utilize 1 pF high-frequency capacitors by Kyocera. At these high frequencies, it is important to consider the parasitic inductance associated with the capacitor. While the impedance due to a capacitor is inversely proportional to the frequency

$$( {X}_{c} = \frac{1}{ω C} ) ,$$

the impedance of the parasitic inductor is ωL. These two impedance's cancel each other out, causing self-resonance and consequently leading to a short circuit. While at low frequencies there is little to no parasitic inductance thus they act as open circuits. By integrating these capacitors at each beam port, one can confine the modulation frequencies within that port.

An FMCW radar operates by autocorrelating the transmitted and received signals. The transmitted signal undergoes a phase shift induced by the time of flight of the signal to and from a target in the environment. Since the signal is frequency-modulated, this phase shift translates into a frequency change. Consequently, autocorrelating the two signals results in an Intermediate frequency which can be represented as:

$$\begin{matrix}IF ( t ) = {A}_{0} \times Re [ exp ( \frac{j 4 π R}{λ ( t )} ) ] \\ = {A}_{0} \times Re [ exp ( j 2 π {f}_{beat} t ) ) ]\end{matrix} \qquad ( 1 )$$

Here, R represents the range of the target, Ao is the amplitude of the IF signal and the

$$λ ( t ) = \frac{c}{St}$$

is the time varying wavelength of the FMCW chirp with slope S and

$${f}_{beat} = \frac{2 RS}{c}$$

is defined as the peat frequency associated with the target and c is the celerity of light in vacuum. By carefully selecting the chirp parameters, one can ensure that the beat frequencies generated by various targets in the environment lie closer to DC. While this approach may not be optimal for capturing passive targets, it provides a straightforward and effective method for detecting tags modulating at frequencies significantly higher than the clutter beat frequencies.

Localizing the tag with respect to the reader follows a straightforward approach. While equation (1) depicts the IF signal for a passive target, it changes for a target which is modulating the interrogation signal and can be represented as:

$$\begin{matrix}IF ( t ) = {A}_{1} \times Re [ exp ( j 2 π {tf}_{beat} t ) ) ] \times sgn [ cos ( 2 π ( 2 n + 1 ) {f}_{tag} t ) ] \\ = {A}_{1} \times Re [ exp ( j 2 π {tf}_{beat} ) ) ] \times {\sum }_{n = 0}^{∞} {a}_{n} cos ( 2 π ( 2 n + 1 ) {f}_{tag} t ) \\ = {A}_{1} \times {\sum }_{n = 0}^{∞} {a}_{n} cos ( 2 π ( ( 2 n + 1 ) {f}_{tag} \pm {f}_{beat} ) t )\end{matrix} \qquad ( 2 )$$

where sgn is the sign function, the an are the coefficients of the Fourier expansion of a square wave, and f_{tag} is the modulation frequency of the modulating target.

The native accuracy of an FMCW radar is typically constrained to c/(2B), where c represents the speed of light and B stands for the bandwidth of the chirp. To enhance this accuracy, the widely adopted method of zero padding is used. This technique involves appending zeroes to the end of the time domain samples. This essentially interpolates between the bins in the frequency domain, thereby improving accuracy.

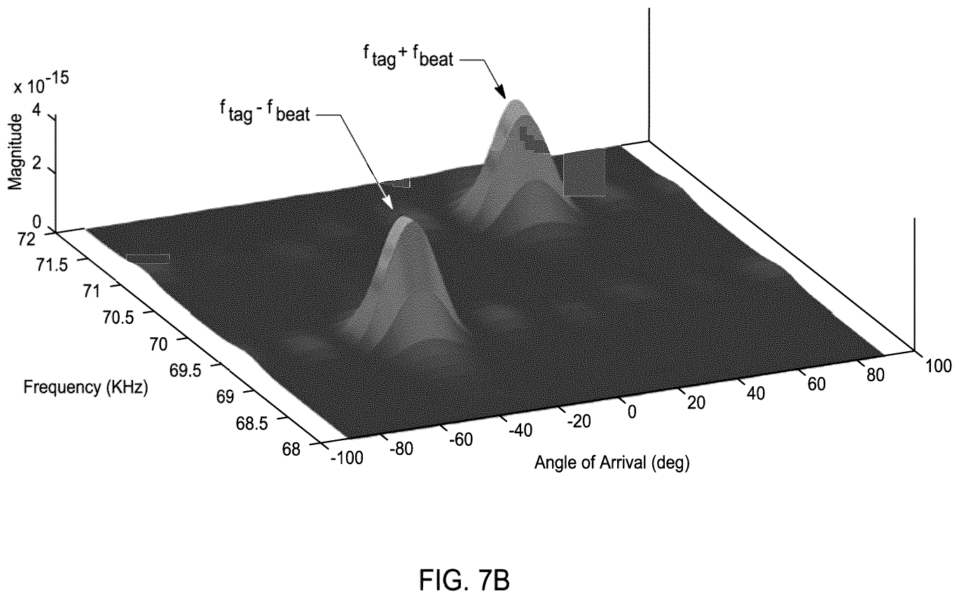

Throughout this work each measurement consists of a 8192-points Fast Fourier Transform (FFT) of the (2×zero-padded) 4096 points of a single chirp sampled at 1.2 MSps over 3.4 ms. A typical measured frequency response of the tag for one of the channels is shown in FIG. 7A. Then the frequencies of the two peaks corresponding to f_{tag}±f_{beat} are extracted. Consequently, the difference between the two peaks yields 2*f_{beat}, enabling us to extract the range of the tag. It must be noted that any of the modulation frequencies can be used to find the f_{tag} and f_{beat} frequencies, since all of them correspond to the same range. Since f_{tag}>>f_{beat}, the IF frequencies of the passive clutter is closer to DC as can be seen in FIG. 7A.

The spatial separation between the Rx channels results in a path difference, which in turn results in a phase difference between the signals, which can then be used to identify the angle of Arrival of the target using:

$$θ = {sin}^{- 1} ( \frac{ϕ λ}{2 π d} ) \qquad ( 3 )$$

where ϕ represents the phase difference between adjacent antennas, d denotes the distance between them, and e signifies the angle of arrival.

A more effective approach to extracting the angle of arrival involves leveraging the periodic nature of the phase change across antennas. Thus, performing a Fast Fourier Transform operation across the receiving antennas provides us with this phase difference, which can then be utilized to extract the Angle of Arrival information.

Now, to extract angular information, the output of the first FFT is followed by a 1024-points (128×zero-padded) FFT over the dimension of the channels, yielding range—angular FFT plots such as the one shown in FIG. 7B. Here, since the interrogation signal is being modulated by the tag, one can see two peaks in the plot, each corresponding to f_{tag}±f_{beat} and angles corresponding to ±ϕ (where ϕ is the phase difference between antennas), which has then been used to find the angle of arrival as explained earlier.

An important parameter to keep in mind is the distance between the receiver antennas as that theoretically dictates the maximum angle of arrival that can be measured. This is because of the fact that the phase difference between the Rx antennas wraps every π radians (due to the two-way propagation of the waves), thereby limiting the maximum angle that can be recorded to:

$${θ}_{max} = {sin}^{- 1} ( \frac{λ}{2 d} ) \qquad ( 4 )$$

To ascertain the orientation of the tag, one can utilize the inherent true time delay capabilities of the Rotman lens. By exciting different beam ports, beams oriented in various directions are generated. Consequently, by discerning the originating beam port responsible for forming each beam, one can determine the orientation of the structure.

In order to distinguish between the different beam ports, one can employ modulation techniques on each port at distinct frequencies. Subsequently, through analysis of these frequencies and their respective amplitudes, one is able to gauge the orientation of the tag.

As depicted in FIG. 3, it is evident that each beam has a width of approximately 15 degrees. Therefore, solely by examining the frequency of the peaks, one can achieve an accuracy of 15 degrees. However, enhancing this precision entails more intricate methodologies. Thus, one can employ a simple regression model to forecast the orientations of the tag.

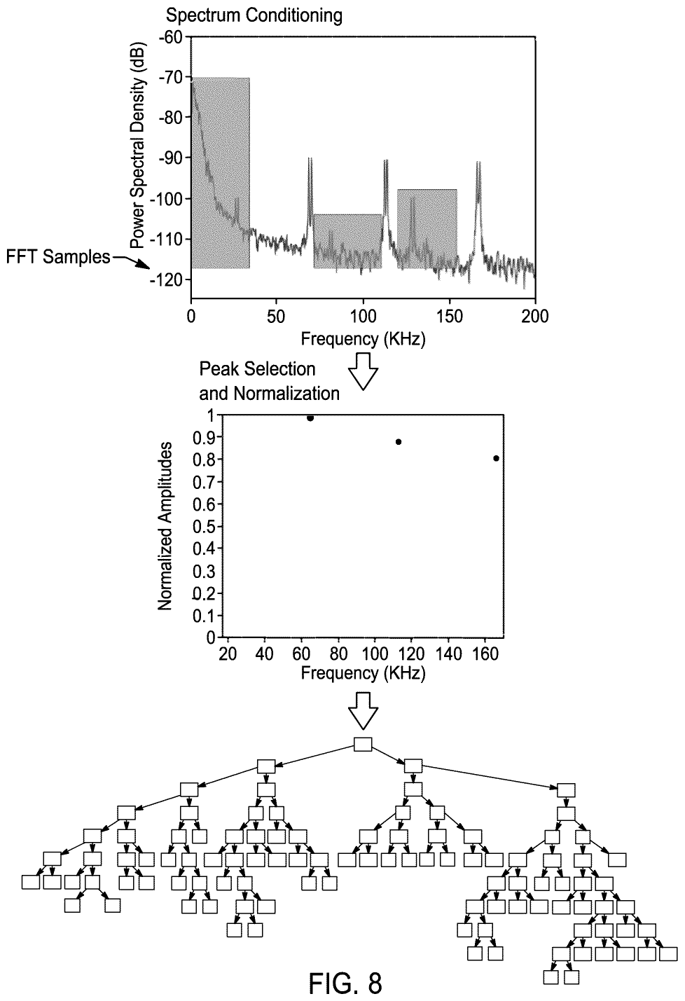

The complete signal processing flowgraph used to estimate the orientation is depicted in FIG. 8. Initially, the frequency spectrum undergoes filtering to eliminate all unwanted signals. Subsequently, all remaining peaks are identified. This process includes the identification of unwanted frequencies resulting from harmonics and suboptimal isolation between ports. To mitigate this, the intermediate frequency (IF) is initially removed from all peaks, achieved by averaging pairs of peaks around various frequencies. This facilitates the isolation of only the modulation frequencies of the tag, which are predetermined. Subsequently, all signals apart from the modulation frequencies are discarded. Given that the modulation frequencies of the tag are not perfectly constant, a certain bandwidth is preserved around each modulation frequency to ensure accuracy.

Here, directly extracting the magnitudes of the peaks at each frequency is not an optimal solution, as the tracked magnitudes may decrease with distance or in the presence of obstacles. This could lead to false positives. While the decrease in magnitude with increasing distance can be calculated using general path loss equations, this method may lack accuracy and does not consider the presence of unknown obstacles.

Therefore, this disclosure opts to extract relative magnitudes rather than absolute magnitudes. Extracting relative magnitudes is essentially equivalent to normalizing the amplitudes. Hence, normalization is performed, and the normalized amplitudes and frequencies are utilized for training or testing the machine learning model.

To collect the training data, the tag undergoes rotation from 40° to −40° at 1° increments. Frequencies and the corresponding normalized amplitudes at each orientation are recorded. This dataset is then employed to train a Random Forest regressor with six trees, as this configuration yielded the highest accuracy. Random Forest was chosen for its robust performance and its capability to handle a relatively wide feature set.

The system was evaluated in mainly three ways: examining the RF performance of the fabricated tag, assessing the system's 2D localization capability, and scrutinizing its orientation sensing abilities.

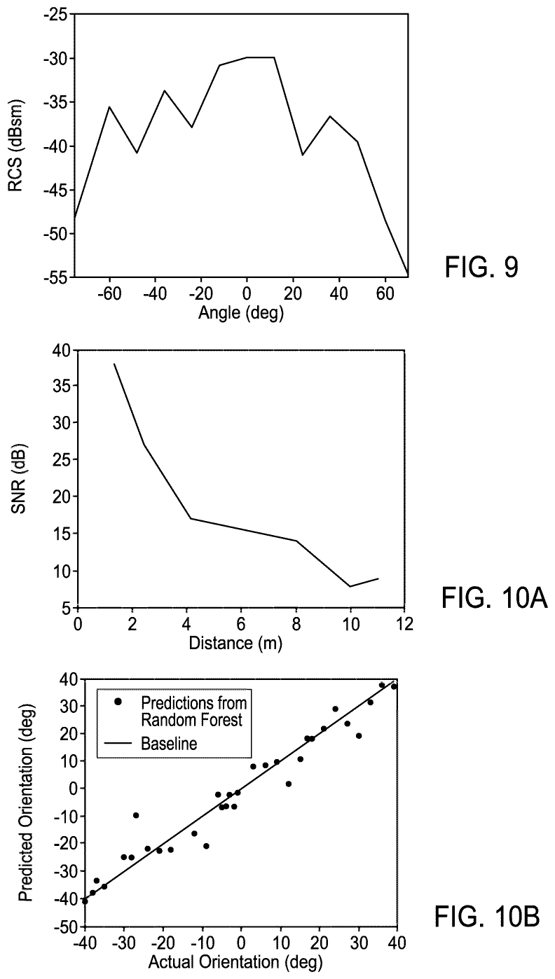

Firstly, the radar cross-section (RCS) of the fabricated tag was measured and is presented in FIG. 9. To measure the RCS, all channels in the tag operated at the same frequency, and the signal strength values were recorded from the response as the tag was tilted from −70° to 70° in azimuth. A CatEcho tag with a known RCS from Atheraxon Inc. was used as a reference. The RCS of the tag decreases by less than 10 dB over a range of +40°, demonstrating wide angular operational coverage.

To assess the performance of tag localization, over 35 measurements were conducted at varying distances up to 11 m. Ground truth was established using a laser range finder in conjunction with an OptiTrack system, with a marker affixed to the tag. The range measurements yielded a median error of 6.4 cm, with a maximum error of 10 cm. Similarly, a median angle of arrival error of 5.8° was observed. These inaccuracies can be readily mitigated through the adoption of more efficient interpolation techniques. The tag was comfortably localized up to a long range of about 11 m. As expected, FIG. 10A illustrates the reduction in SNR with increasing distance. Here, signal strength is defined as the signal power corresponding to a particular frequency and orientation, rather than the integrated power from all the modulation frequencies.

The evaluation of the system's orientation estimation relies on assessing the regression model. Here, a dataset comprising 80 measurements is used for training, while 33 diverse measurements were recorded for testing, covering a broad spectrum of orientations to detect any overfitting in the random forest model. Additionally, the testing dataset included measurements where the tag's frequency slightly deviated from that observed in the training dataset. This analysis revealed a mean absolute error of 3.6 degrees and a mean squared error of 5.2 degrees.

The advantage of utilizing the ML model becomes evident when observing FIG. 10B, which showcases the comparison between predicted and actual orientation measurements. A notable observation from FIG. 10B is that the error in the predicted values remains consistent across various orientations. Without the ML model, one would expect relatively higher accuracy at orientations between the peak gains of each beam port, where the change in the received signal strength with respect to the change in orientation is highest, whereas accuracy would likely decrease at orientations around the peak of a particular beam due to the nearly constant gain.

The presented system enables the 3 Degrees Of Freedom (DOF)—range, azimuth, and yaw—spatial measurement of an ultra-low-power tag at ranges exceeding 10 m with mean errors of less than 6.4 cm, 5.8°, and 3.6°, respectively. This work puts the long-range 5DOF (all but pitch) localization of ultra-low-power tags in clear line of sight, using a combination of lens-based tags and array radars. Such capabilities have the potential to significantly enhance the spatial awareness of mobile computer systems, including Augmented and Virtual Reality Headsets, industrial robots, and autonomous vehicles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A localization and orientation sensing tag, comprising:
a Rotman lens having a plurality of array ports and a plurality of beam ports;
a set of receiving antennas, each antenna in the set of receiving antennas is electrically coupled to a different port in the array of ports of the Rotman lens;
a set of transmitting antennas, each antenna in the set of transmitting antennas is electrically coupled to a different port in the plurality of beam ports of the Rotman lens;
a set of switches, where a switch from the set of switches is disposed in each path electrically coupling a port in the plurality of beam ports to an antenna in the set of transmitting antennas; and
a baseband circuit interfaced with each switch in the set of switches.

2. The sensing tag of claim 1 wherein each antenna in the set of receiving antenna is further defined as a patch antenna.

3. The sensing tag of claim 1 wherein antennas in the set of receiving antennas are vertically polarized and antennas in the set of transmitting antennas are horizontally polarized.

4. The sensing tag of claim 1 wherein the baseband circuit operates to modulate signals at different frequencies prior to the signals reaching an antenna in the set of transmitting antennas.

5. The sensing tag of claim 4 wherein the baseband circuit modulates signals by turning on and off switches in the set of switches.

6. The sensing tag of claim 1 further comprises a capacitor disposed in each path electrically coupling a port in the plurality of beam ports to an antenna in the set of transmitting antennas.

7. The sensing tag of claim 1 is integrated into a vehicle.

8. A localization and orientation sensing tag, comprising:
a passive beam forming network having a plurality of array ports and a plurality of beam ports;
a set of receiving antennas, each antenna in the set of receiving antennas is electrically coupled to a different port in the array of ports of the beam forming network, wherein beams incident upon the set of receiving antennas from different directions are directed to different ports in the plurality of beam ports of the beam forming network;
a set of transmitting antennas, each antenna in the set of transmitting antennas is electrically coupled to a different port in the plurality of beam ports of the beam forming network;
a set of switches, where a switch from the set of switches is disposed in each path electrically coupling a port in the plurality of beam ports to an antenna in the set of transmitting antennas; and
a baseband circuit interfaced with each switch in the set of switches.

9. The sensing tag of claim 8 wherein the beam forming network is further defined as one of a Buttler matrix, a Blass matrix or a Nolen matrix.

10. The sensing tag of claim 8 wherein the beam forming network is further defined as one of a dielectric lens, a Frensel lens, or a Luneburg lens.

11. The sensing tag of claim 8 wherein each antenna in the set of receiving antenna is further defined as a patch antenna.

12. The sensing tag of claim 8 wherein antennas in the set of receiving antennas are vertically polarized and antennas in the set of transmitting antennas are horizontally polarized.

13. The sensing tag of claim 8 wherein the baseband circuit operates to modulate signals at different frequencies prior to the signals reaching an antenna in the set of transmitting antennas.

14. The sensing tag of claim 13 wherein the baseband circuit modulates signals by turning on and off switches in the set of switches.

15. The sensing tag of claim 8 further comprises a capacitor disposed in each path electrically coupling a port in the plurality of beam ports to an antenna in the set of transmitting antennas.

16. The sensing tag of claim 8 is integrated into a vehicle.
